(19) United States
(12) Patent Application Publication
(10) Pub. No.: US 2022/0231330 A1
(43) Pub. Date: Jul. 21, 2022

(54) METHOD FOR PREPARING LITHIUM PHOSPHATE SULFIDE SOLID ELECTROLYTES

(71) Applicant: Battelle Memorial Institute, Richland, WA (US)

(72) Inventors: Xin Zhang, Richland, WA (US); Jianbin Zhou, San Diego, CA (US); Wei Wang, West Richland, WA (US); Dongping Lu, Richland, WA (US); Mark E. Bowden, Richland, WA (US)

(73) Assignee: Battelle Memorial Institute, Richland, WA (US)

(21) Appl. No.: 17/580,306

(22) Filed: Jan. 20, 2022

Related U.S. Application Data
(60) Provisional application No. 63/139,592, filed on Jan. 20, 2021.

(51) Int. Cl. H01M 10/0562

(52) U.S. Cl. CPC H01M 10/0562; H01M 2300/0068

(57) ABSTRACT

Nanosized lithium phosphate sulfide solid state electrolytes are synthesized by a facile method using ethyl acetate as the solvent. SSE compositions comprising nanosized lithium phosphate sulfide synthesized using the methods include particles having an average diameter of from 50 nm to 1000 nm. The nanosized lithium phosphate sulfide has a formula LiₓP_{y}S_{z}, wherein 3≤x ≤7, 1≤y≤3, and 4≤z≤11.

### CROSS REFERENCE TO RELATED APPLICATION

This application claims the benefit of the earlier filing date of U.S. Provisional Application No. 63/139,592, filed Jan. 20, 2021, which is incorporated by reference in its entirety herein.

### ACKNOWLEDGMENT OF GOVERNMENT SUPPORT

This invention was made with Government support under Contract DE-AC0576RL01830 awarded by the U.S. Department of Energy. The Government has certain rights in the invention.

### FIELD Methods for preparing lithium phosphate sulfide solid electrolytes are disclosed, as well as lithium phosphate sulfide solid electrolytes prepared by the methods.

### SUMMARY

Embodiments of methods for making nanosized lithium phosphate sulfide (LiPS) solid state electrolytes (SSEs) are disclosed. In some embodiments, the synthesized SSEs comprise nanoparticles of LiPS having a formula LiₓP_{y}S_{z}, wherein 3≤x≤7, 1≤y≤3, and 4≤z≤11. In certain embodiments, the synthesized SSEs further comprise an amorphous material.

In some embodiments, the LiPS SSEs are made by (a) combining precursors with an organic solvent to provide a composition; (b) mixing the composition at a dissolving temperature for an effective period of time to fully dissolve the precursors and form a solution; (c) evaporating the solvent at an evaporating temperature to produce a solid composition; and (d) heating the solid composition at a heating temperature for a heating time to produce a final product.

In any of the foregoing or following embodiments, the precursors may be a mixture of Li₂S and P₂S₅ with a molar ratio of 7:3, the organic solvent is ethyl acetate (EA), and the solution contains from 5 mg ml⁻¹ to 40 mg ml⁻¹ of the precursors. In certain embodiments, the solution contains from 10 to 20 mg ml⁻¹ of the precursors.

In any of the foregoing or following embodiments, the dissolving temperature may be from 40° C. to 60° C., and/or the effective period of time to fully dissolve the precursors may be at least 1 hour.

In any of the foregoing or following embodiments, the evaporating temperature may be from 70° C. to 130° C. In some embodiments, the evaporating temperature is from 80° C. to 100° C. In any of the foregoing or following embodiments, the disclosed methods may generate intermediates after evaporating the solvent. In some embodiments, the intermediates comprising nanoparticles of Li₃PS₄ coated with amorphous materials having a formula LiₓP_{y}S_{z}, wherein 3≤x≤7, 1≤y≤3, and 4≤z≤11.

In any of the foregoing or following embodiments, the heating temperature may be from 260° C. to 280° C. and/or the heating time may be from 1 to 3 hours.

SSE compositions comprising LiPS made by any of the foregoing embodiments of the method also are disclosed. In any of the following embodiments, the final product may be an SSE composition comprising LiPS SSEs. In some embodiments, the SSE composition comprises nanoparticles of LiPS. In certain embodiments, the SSE composition comprises, consists essentially of, or consists of nanoparticles of Li₇P₃S₁₁. As used herein, the term “consists essentially of” means that the composition does not include other components that may materially affect properties of the SSE, such as Li⁺ conductivity and/or electron conductivity. For example, the composition may include trace amounts (e.g., less than 0.5 wt % of the organic solvent) but does not include other LiPS species or other lithium-containing compounds. In some embodiments, the SSE compositions comprise from 80 wt % to 99.99 wt % of nanoparticles of Li₇P₃S₁₁. In some embodiments, the SSE compositions further comprise amorphous materials comprising LiPS.

In some embodiments, the synthesized nanoparticles of LiPS have an average diameter of from 50 nm to 1000 nm. In certain embodiments, the nanoparticles of LiPS have an average particle diameter of from 100 nm to 1000 nm, from 100 nm to 500 nm, from 100 nm to 120 nm, and from 150 nm to 450 nm. In any or all of the foregoing or following embodiments, the SSEs may exhibit a Li⁺ conductivity of at least 0.7 mS cm⁻¹. In some embodiments, the SSEs exhibit a Li⁺ conductivity of at least 1.05 mS cm⁻¹. In some embodiments, the SSEs exhibit an electron conductivity of from 1×10⁻⁷ to 1×10⁻⁶ mS cm⁻¹.

In some implementations, the SSE compositions are made by embodiments of the disclosed methods, wherein the precursors are mixture of Li₂S and P₂S₅ with a molar ratio of 7:3, the organic solvent is EA, the dissolving temperature is from 40 to 60° C., the effective period of time is at least 1 hour, the evaporating temperature is from 80 to 100° C., and the heating temperature is 260° C. In one embodiment, the concentration of the precursors in EA is 10 mg ml⁻¹, the SSE composition comprises Li₇P₃S₁₁ nanoparticles having an average diameter of from 100 nm to 120 nm, and the SSEs exhibit a Li⁺ conductivity of at least 0.7 mS cm⁻¹. In another embodiment, the concentration of the precursors in EA is 20 mg ml⁻¹, the SSE composition comprises Li₇P₃S₁₁ nanoparticles having an average diameter of from 150 nm to 450 nm, and the SSEs exhibit a Li⁺ conductivity of at least 1.05 mS cm⁻¹.

The foregoing and other objects, features, and advantages of the invention will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows cryogenic transmission electron microscopy (Cryo-TEM) images of a composition comprising nanoparticles of Li₇P₃S₁₁, nanoparticles of Li₃PS₄, and amorphous materials.

FIGS. 2A-2F show photographs of 7Li₂S-3P₂S₅ dissolved in EA, acetonitrile (ACN), tetrahydrofuran (THF) and 1,2-dimethoxyethane (DME) solvents under the same concentration of 10 mg ml⁻¹ (FIG. 2A); scanning electron microscopy (SEM) images of Li₇P₃S₁₁ products prepared with EA solvent (FIG. 2B); energy-dispersive X-ray spectroscopy (EDS) mapping images of Li₇P₃S₁₁ products prepared with EA solvent (FIG. 2C); X-ray diffraction (XRD) patterns of Li₇P₃S₁₁ prepared with EA and ACN solvents (FIG. 2D). Raman spectra of Li₇P₃S₁₁ samples with EA and ACN solvents (FIG. 2E); and electrochemical impedance spectroscopy (EIS) of Li₇P₃S₁₁ products prepared with EA solvent (FIG. 2F).

FIG. 3 shows the XRD patterns (Cr target) of Li₇P₃S₁₁ prepared with EA and ACN solvents, related to FIG. 2D.

FIG. 4 is the corresponding SEM image of Li₇P₃S₁₁ prepared with EA for EDS mapping, related to FIG. 2C.

FIGS. 5A-5C are large scale and magnified SEM images of Li₇P₃S₁₁ nanoparticles prepared with EA, 10 mg ml⁻¹, at a solvent evaporation temperature of 100° C. FIGS. 5B and 5C were obtained via ultra-sonication dispersing as-synthetic Li₇P₃S₁₁ nanoparticles in anhydrous toluene solutions and then dropping and drying the solution on a Si wafer for SEM imaging.

FIGS. 6A-6D show the particle size distribution of Li₇P₃S₁₁ samples prepared with EA (FIG. 6A), ACN (FIG. 6B), THF (FIG. 6C) and DME (FIG. 6D) solvents.

FIGS. 7A-7C are SEM images of Li₇P₃S₁₁ samples prepared with ACN (FIG. 7A), THF (FIG. 7B) and DME (FIG. 7C) solvents.

FIGS. 8A-8F show Raman spectra of Li₂S, P₂S₅, EA and the mixture of 7Li₂S-3P₂S₅/EA (FIG. 8A); ³¹P nuclear magnetic resonance (³¹P NMR) spectra of 7Li₂S-3P₂S₅/EA, 7Li₂S-3P₂S₅/γ-butyrolactone (BA) and the supernatant of 7Li₂S-3P₂S₅/ACN (FIG. 8B); in-situ heating XRD contour plots with the patterns every 10° C. from 100° C. to 400° C. (FIG. 8C); thermogravimetric and mass spectrometry (TGA-MS) curves of 7Li₂S-3P₂S₅/EA-100 (FIG. 8D); TGA-MS curves of 7Li₂S-3P₂S₅/ACN-150 (FIG. 8E); a schematic synthesis mechanism of Li₇P₃S₁₁ via EA solvent (FIG. 8F).

FIG. 9 shows the Fourier-transform infrared (FT-IR) spectra of Li₂S, P₂S₅, EA solvent and 7Li₂S-3P₂S₅/EA.

FIGS. 10A-10B show a digital image of 7Li₂S-3P₂S₅/BA solution (FIG. 10A); the XRD patterns of samples after evaporating BA solvent at 220° C. and heating treatment at 260° C. (FIG. 10B).

FIG. 11 shows the ⁷Li NMR spectra of 7Li₂S-3P₂S₅/EA (Blue), 7Li₂S-3P₂S₅/BA supernatant (Orange) and 7Li₂S-3P₂S₅/BA (Red).

FIG. 12 shows the XRD patterns of commercial Li₂S, P₂S₅, 7Li₂S-3P₂S₅/EA-100 and 7Li₂S-3P₂S₅/EA-260 (Li₇P₃S₁₁).

FIG. 13 shows the in-situ heating XRD patterns of 7Li₂S-3P₂S₅/EA-100 from 100° C. to 400° C. every 10° C., related to FIG. 8C.

FIG. 14A shows the TGA-MS curves of 7Li₂S-3P₂S₅/BA-220. FIG. 14B shows the TGA-MS curves of simply mixed 7Li₂S-3P₂S₅.

FIGS. 15A-15l are SEM images of Li7P₃S₁₁ samples synthesized at different concentrations and evaporation temperatures followed by heating at 260° C.: —Li₇P₃S₁₁ synthesized with a concentration of 10 mg ml⁻¹ with an evaporation temperature of 100° C. (FIG. 15A); Li₇P₃S₁₁ synthesized with a concentration of 20 mg ml⁻¹ with an evaporation temperature of 100° C. (FIG. 15B); Li7P3S11 synthesized with a concentration of 40 mg ml⁻¹ with an evaporation temperature of 100° C. (FIG. 15C); Li₇P₃S₁₁ synthesized with a concentration of 10 mg ml⁻¹ with an evaporation temperatures of 80° C. (FIG. 15D); Li₇P₃S₁₁ synthesized with a concentration of 20 mg ml⁻¹ with an evaporation temperature of 80° C. (FIG. 15E); Li₇P₃S₁₁ synthesized with a concentration of 40 mg ml⁻¹ with an evaporation temperature of 80° C. (FIG. 15F); Li₇P₃S₁₁ synthesized with a concentration of 10 mg ml⁻¹ with an evaporation temperature of 150° C. (FIG. 15G); Li₇P₃S₁₁ synthesized with a concentration of 20 mg ml⁻¹ with an evaporation temperature of 50° C. (FIG. 15H); Li₇P₃S₁₁ synthesized with a concentration of 40 mg ml⁻¹ with an evaporation temperature of 150° C. (FIG. 151).

FIG. 16A-16C are SEM images of 7Li₂S-3P₂S₅/EA-100 prepared at the concentrations of 10 mg ml⁻¹, 20 mg ml⁻¹, and 40 mg ml⁻¹, respectively.

FIG. 17 shows the XRD diffraction patterns of 40 mg ml⁻¹−100° C., 20 mg ml⁻¹−100° C. and 10 mg ml⁻¹−100° C. samples obtained at different concentrations.

FIGS. 18A-18D show the room temperature Li⁺ conductivity of nine samples of FIG. 15 (FIG. 18A); the electronic conductivity of 10 mg ml⁻¹−100° C. sample (FIGS. 18B-18C); the cycling performance of Li/Li₇P₃S1₁/Li symmetric cell at 0.1 mA cm⁻² with 10 mg ml⁻¹−100° C. sample (FIG. 18D). FIGS. 19A-19D shows the SEM images (FIGS. 19A-19B), XRD (FIG. 19C) and EIS at room temperature (FIG. 19D) of synthesized Li₃PS₄ nanoparticles with a concentration of 10 mg ml⁻¹ and an evaporation temperature of 100° C.

### DETAILED DESCRIPTION

This disclosure concerns embodiments of solid-state electrolytes (SSEs) comprising lithium phosphate sulfide (LiPS) nanoparticles with controllable particle sizes and scalable synthesis methods of making the LiPS nanoparticles.

The development of rechargeable lithium-ion batteries (LIBs) with high energy density and safety is urgently required. However, traditional LIBs with flammable liquid electrolytes have raised great safety concerns and will soon approach their energy density limits. Compared to traditional LIBs, all-solid-state lithium batteries (ASSLBs) with SSEs provide new opportunities to solve the safety concerns and achieve a higher energy density simultaneously.

Among all developed SSEs, Li₇P₃S₁₁ has been regarded as one of the most promising electrolytes for practical applications due to its lower activation energy (17 kJ mol⁻¹) and superior theoretical Li⁺ conductivity (7.2×10⁻² S cm⁻¹) at room temperature, which is comparable to widely used organic liquid electrolytes. However, for the commercialization of ASSLBs, the high interfacial resistance between cathode materials and SSEs is a significant barrier for system integration and cell energy improvement, which is deeply intertwined with the Li⁺ conductivity, the particle size of SSEs, chemical compatibilities. Small-sized SSE particles with high Li⁺ conductivity may benefit the migration of Li⁺ across the active materials/SSEs interface by creating a thin contact layer to decrease the interfacial resistance, which also improves the energy density of ASSLBs with fewer SSE particles in the electrode. Moreover, the small-sized SSE particles can also decrease the defects between SSEs particles and benefit the long cycling stability of solid cell. Due to the soft and dynamic lattice, Li₇P₃S₁₁ makes it more feasible to achieve such a performance than other SSEs. Therefore, the size controlled synthesis of Li₇P₃S₁₁ SSEs is a promising path to developing practical ASSLBs. However, synthesizing Li₇P₃S₁₁ nanoparticles that also exhibit high Li⁺ is challenging. The precursors are difficult or impossible to dissolve in most solvents. Additionally, the high binding energy of residual solvent molecules with Li₃PS₄ further limits the Li⁺ conductivity for Li₇P₃S₁₁. The inventors have solved these problems with the disclosed synthesis methods. Embodiments of facile wet-chemical methods to synthesize Li₇P₃S₁₁ with controlled nanoparticle sizes and high Li⁺ conductivity are disclosed. Advantageously, the precursors may be readily dissolved in ethyl acetate (EA) within just a few hours. Attempts were made to dissolve single part of Li₂S or P₂S₅ at the same concentrations in 7Li₂S-3P₂S₅. Surprisingly, the inventors discovered that neither precursor alone can be dissolved in EA solutions, but that the mixture was soluble. Therefore, it was concluded that EA possesses a very strong solvation ability toward the 7Li₂S-3P₂S₅ mixture, and not the single components, by the full solvation of Li⁺, PS₄³⁻ and thiophosphate-based groups. Embodiments of SSE compositions comprising Li₇P₃S₁₁ synthesized using the methods are also disclosed. By fully dissolving 7Li₂S-3P₂S₅ precursors in EA, Li₇P₃S₁₁ nanoparticles with diameters from 50 nm to 1000 nm can be synthesized. In some embodiments, the obtained SSE compositions comprising Li₇P₃S₁₁ particles reveal a Li⁺ conductivity of at least 0.7 mS cm⁻¹ and/or ultralow electron conductivity, which shows great potential for future practical applications. A mechanism study suggests that the unique solvability and low binding energy of EA solvent toward the solutes may play a key role in controlling the particle diameters. In addition, the EA solvent is inexpensive, exhibits low toxicity, and is suitable for industrial production.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims. The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Consists essentially of: As used herein, the term “consist essentially of” means that the composition does not include other components that may materially affect properties of the SSE, such as components that may measurably alter Li⁺ conductivity and/or electron conductivity. For example, embodiments of the disclosed SSEs may include trace amounts (e.g., less than 0.5 wt % of the organic solvent) but do not include LiPS species other than those disclosed or other lithium-containing compounds.

Ethyl acetate (EA): Ethyl acetate is an organic compound with a formula CH₃—COO—CH₂—CH₃, simplified to C₄H₈O₂. It is the ester of ethanol and acetic acid.

Lithium phosphate sulfide (LiPS): As used herein, the term “lithium phosphate sulfide” (LiPS) refers to a solid-state electrolyte with the general formula LiPS where 3≤x≤7, 1≤y≤3, and 4≤z≤11.

Nanoparticle: As used herein, the term “nanoparticle” refers to a nanoscale particle with a diameter that is measured in nanometers, for example, a nanoscopic particle that has at least one dimension of 150 nm.

Precursor: A precursor participates in a chemical reaction to form another compound. As used herein, the term “precursor” refers to compounds used to prepare lithium phosphate sulfide solid-state electrolytes.

Solid state: Composed of solid components. As defined herein, a solid-state synthesis proceeds with solid components directly without using sintering agents.

Solid state electrolyte (SSE): A solid-state electrolyte is a solid ionic conductor and electron-insulating material, and it is the characteristic component of a solid-state battery.

Solution: A homogeneous mixture of two or more components. In such a mixture, a solute is a substance dissolved in another substance, known as a solvent. A solution is composed of only one phase. The components of a solution include atoms, ions, and/or molecules.

### II. Synthesis of Nanosized Lithium Phosphate Sulfide Solid State Electrolytes

Embodiments of methods for making nanosized lithium phosphate sulfide (LiPS) solid state electrolytes (SSEs) are disclosed. In some embodiments, the method includes combining a mixture of precursors with ethyl acetate to provide a composition comprising the precursors in the ethyl acetate; mixing the composition at a dissolving temperature for an effective period of time to fully dissolve the precursors and form a solution; evaporating the ethyl acetate at an evaporating temperature to produce a solid composition; and heating the solid composition at a heating temperature to produce a solid state electrolyte comprising nanoparticles of lithium phosphate sulfide. In certain embodiments, the precursors comprise Li₂S and P₂S₅. In any of the foregoing or following embodiments, the method may be performed at atmospheric pressure.

In some embodiments, the synthesized SSE comprises LiPS having a formula LiₓP_{y}S_{z} where 3≤x≤7, 1≤y≤3, and 4≤z≤11. In one embodiment, x=7, y=3, and z=11. In another embodiment, x=3, y=1, and z=4. In some embodiments, the LiPS comprises nanoparticles of LiPS. The SSE further may comprise an amorphous material comprising LiₓP_{y}S_{z}.

In any of the foregoing or following embodiments, evaporating the ethyl acetate may produce a solid composition comprising one or more intermediates. In some embodiments, the intermediates comprise one or more species of LiPS having a formula LiₓP_{y}S_{z}. In some embodiments, 2≤x≤7, 1≤y≤4, and 4≤z≤11. In certain embodiments, x=3, y=1, and z=4. In some embodiments, the intermediates comprise LiₓP_{y}S_{z} nanoparticles. In some embodiments, the intermediates further comprise and amorphous material. The amorphous material may coat at least some of the nanoparticles. Thus, in some embodiments, the intermediates comprise nanoparticles coated with amorphous material.

In any or all of the foregoing or following embodiments, the LiPS SSEs prepared by the disclosed methods may exhibit a Li⁺ conductivity of at least 0.7 mS cm⁻¹, such as at least 0.75 mS cm⁻¹, at least 0.8 mS cm⁻¹, at least 0.85 mS cm⁻¹, at least 0.9 mS cm⁻¹, at least 0.95 mS cm^{'1}, or at least 1.0 mS cm⁻¹. In some embodiments, the LiPS SSEs exhibit a Li⁺ conductivity of from 0.7 mS cm⁻¹ to 1.5 mS cm⁻¹, such as 0.7 mS cm⁻¹ to 1.3 mS cm⁻¹, or 0.7 mS cm⁻¹ to 1.1 mS cm⁻¹. In some embodiments, the LiPS SSEs exhibit a Li⁺ conductivity of at least 1.05 mS cm⁻¹.

In any or all of the foregoing or following embodiments, the LiPS SSEs prepared by the disclosed methods may exhibit an electron conductivity of from 1×10⁻⁷ to 1×10⁻⁶ mS cm⁻¹, such as 1.5×10⁻⁷ to 3.0×10⁻⁷ mS cm⁻¹, 2×10⁻⁷ to 8×10⁻⁷ mS cm⁻¹, 2×10⁻⁷ to 5×10⁻⁷ mS cm⁻¹, or 2×10⁻⁷ to 4×10⁻⁷ mS cm⁻¹. In certain embodiments, the LiPS SSEs exhibit an electron conductivity of 2×10⁻⁷ mS cm⁻¹ to 2.5×10⁻⁷ mS cm⁻¹.

In any or all of the foregoing or following embodiments, the LiPS nanoparticles prepared by the disclosed methods may have an average diameter of from 50 nm to 1000 nm, such as from 60 nm to 900 nm, from 70 nm to 800 nm, from 80 nm to 700 nm, from 90 nm to 600 nm, or from 100 nm to 500 nm. In certain embodiments, the LiPS nanoparticles have an average particle diameter of from 150 nm to 450 nm. In certain embodiments, the LiPS nanoparticles have an average particle diameter of from 100 nm to 120 nm.

### A. Dissolving the precursors

In any or all of the foregoing or following embodiments, the methods for synthesizing nanosized LiPS SSEs may include dissolving precursors in an organic solvent. In some embodiments, the precursors comprise a mixture of Li₂S and P₂S₅. In some embodiments, the precursors are Li₂S and P₂S₅ with average particle diameters of less than 500 μm.

In any of the foregoing or following embodiments, the precursors may comprise Li₂S and P₂S₅ with a suitable molar ratio for forming the desired LiPS product. In some embodiments, the precursors comprise, consist essentially of, or consist of a mixture of Li₂S and P₂S₅with a molar ratio of from 6:4 to 8:2. In one embodiment, the precursors comprise, consist essentially of, or consist of a mixture of Li₂S and P₂S₅with a molar ratio of 7:3 (7Li₂S-3P₂S₅). In some embodiments, the precursors comprise, consist essentially of, or consist of a mixture of Li₂S and P₂S₅ with a molar ratio of from 2.5:1 to 3.5:1. In one embodiment, the precursors comprise, consist essentially of, or consist of a mixture of Li₂S and P₂S₅with a molar ratio of 3:1.

The precursors are dissolved in an organic solvent. In some embodiments, the organic solvent readily solubilizes the precursors, has a relatively low toxicity, and is suitable for industrial production. In some embodiments, the precursors are Li₂S and P₂S₅, and the organic solvent possesses a strong solvation ability toward the precursors. In some embodiments, the organic solvent is ethyl acetate (EA). While the precursors are not readily soluble in EA, surprisingly the mixture of Li₂S and P₂S₅ is easily solubilized.

In any of the foregoing or following embodiments, the precursors may be combined with the organic solvent in an amount to provide a composition comprising 1 to 100 mg ml⁻¹ of the precursors. In some embodiments, the concentration of precursors in the composition is 1 to 100 mg ml⁻¹, 2 to 80 mg ml⁻¹, 3 to 60 mg ml⁻¹, 4 to 50 mg ml⁻¹, 5 to 40 mg ml⁻¹, or 10 to 20 mg ml⁻¹. In some embodiments, the concentration of precursors in the solution is 10 mg ml⁻¹, 20 mg ml⁻¹, or 40 mg ml⁻¹. In certain embodiments, the precursors are 7Li₂S-3P₂S₅, the organic solvent is EA, and the concentration of 7Li₂S-3P₂S₅ in EA is 5 to 40 mg ml⁻¹, such as 10 mg ml⁻¹, 20 mg ml⁻¹, or 40 mg ml⁻¹.

The method for synthesizing nanosized LiPS SSEs further comprises mixing the composition at a dissolving temperature for an effective period of time to fully dissolve the precursors and form a solution. In some embodiments, the composition forms a homogeneous solution after mixing at the dissolving temperature for the effective period of time. Mixing may be performed by any suitable means including, but not limited to, stirring, shaking, agitating, vortexing, sonicating, and the like. In some embodiments, mixing comprises stirring.

In some embodiments, the dissolving temperature is 10° C. to 100° C., such as 20° C. to 80° C., 30° C. to 70° C., or 40° C. to 60° C. In certain embodiments, the dissolving temperature is 50° C. In one embodiment, the solution is EA, the precursors are 7Li₂S-3P₂S₅, and the dissolving temperature to fully dissolve 7Li₂S-3P₂S₅ is 50° C.

In some embodiments, the effective period of time to fully dissolve the precursors in the organic solvent while mixing at the dissolving temperature is at least 1 hour or at least 1.5 hours. In some embodiments, the effective period of time is 1 to 4 hours, 1 to 3 hours, or 1.5 to 2.5 hours. In certain embodiments, the effective period of time is 2 hours. In some embodiments, the solution is EA, the precursors are 7Li₂S-3P₂S₅, the dissolving temperature is from 40 to 60 ° C., and the effective period of time to fully dissolve 7Li₂S-3P₂S₅ in a concentration of 5 mg ml⁻¹ to 40 mg ml⁻¹ is 2 hours. Advantageously, the effective period of time is much less than the time required with other solvents.

For example, other common solvents such as acetonitrile, tetrahydrofuran, and dimethoxyethane have low solubility towards both precursors and their mixtures, and do not fully dissolve the precursors even after heating and mixing for 72 hours.

### B. Evaporating the Solvent

The methods for synthesizing nanosized LiPS SSEs further comprise evaporating the solvent at an evaporating temperature to provide a solid composition. In some embodiments, the solid composition comprises one or more intermediates. In some embodiments, the intermediates comprise nanoparticles, amorphous materials, or a combination of nanoparticles and amorphous materials. In certain embodiments, the intermediates comprise a plurality of nanoparticles coated with an amorphous material. The intermediates may comprise one or more species of LiPS having a formula LiₓP_{y}S_{z}, wherein 3≤x≤7, 1≤y≤3, and 4≤z≤11. In some embodiments, the intermediates comprise Li₃PS₄, Li₇P₃S₁₁, other LiPS species, or a combination thereof. In some embodiments, gradually evaporating the solvent at an evaporating temperature firstly leads to nucleation of nanoparticles. In some embodiments, gradually evaporating the solvent at an evaporating temperature further leads to formation of an amorphous material coating on the surfaces of at least some of the nanoparticles. In some embodiments, the intermediates generated by evaporating the solvent comprise Li₃PS₄ nanoparticles and an amorphous material. The amorphous material may be present as a coating on some or all of the nanoparticles.

In some embodiments, the evaporating temperature is from 40° C. to 250° C., from 50° C. to 220° C., from 55° C. to 200° C., from 60° C. to 180° C., from 65° C. to 150° C., from 70° C. to 130° C., from 75° C. to 125° C., from 80° C. to 120° C., from 90° C. to 110° C., or from 95° C. to 105° C. In some embodiments, the evaporating temperature is 80° C., 100° C., or 150° C. In one embodiment, the solvent is EA, and the evaporating temperature is 100° C.

### C. Heating the Solid Composition

The methods for synthesizing nanosized LiPS SSEs further comprise heating the solid composition at a heating temperature for a heating time to generate an SSE. In some embodiments, the SSE comprises nanosized LiPS. In some embodiments, the nanosized LiPS comprises, consists essentially of, or consists of nanoparticles of Li₇P₃S₁₁. In some examples, the solid composition was heated in a sealed autoclave to generate the final product.

In some embodiments, the heating temperature is from 100° C. to 400° C., from 110° C. to 390° C., from 120° C. to 380° C., from 130° C. to 370 ° C., from 140° C. to 360° C., from 150° C. to 350° C., from 160° C. to 340° C., from 180° C. to 330° C., from 200° C. to 320° C., from 210° C. to 310° C., from 230° C. to 300° C., from 250° C. to 290° C., from 260° C. to 280° C., or from 260° C. to 270° C. In certain embodiments, the intermediates are heated at 260° C.

In any of the foregoing embodiments, the heating time may be from 0.5 to 3 hours, from 0.5 to 2 hours, from 0.5 to 1.5 hours, or from 1 to 1.5 hours. In certain embodiments, the intermediates are heated at a heating temperature from 260° C. to 280° C., and the heating time is from 1 to 3 hours. In certain embodiments, the solid composition comprising the intermediates is heated at a heating temperature from 260° C. to 280° C., and the heating time is from 0.5 to 1.5 hours.

### III. Lithium Phosphate Sulfide Solid State Electrolytes

Solid state electrolytes (SSEs) comprising lithium phosphate sulfide (LiPS) made by embodiments of the methods are disclosed. In some embodiments, the SSE comprises one or more species of LiPS. In certain embodiments, the SSE comprises nanoparticles of LiPS. In some implementations, the SSE further comprises an amorphous material comprising LiPS. In any or all of the foregoing or following embodiments, the one or more LiPS has a formula LiₓP_{y}S_{z}. In certain embodiments, 3≤x≤7, 1≤y≤3, and 4≤z≤11. Advantageously, the SSE comprises nanoparticles of Li₇P₃S₁₁ having an average diameter of from 50 nm to 1000 nm, such as from 60 nm to 900 nm, from 70 nm to 800 nm, from 80 nm to 700 nm, from 90 nm to 600 nm, or from 100 nm to 500 nm. In certain embodiments, the nanoparticles of LiPS have an average particle diameter of from 150 nm to 450 nm. In certain embodiments, the nanoparticles of LiPS have an average particle diameter of from 100 nm to 120 nm.

### A. SSE Comprising Li₇P₃S₁₁ Nanoparticles

In some embodiments, the SSE comprises, consists essentially of, or consists of nanoparticles of LiPS with a formula LiₓP_{y}S_{z}, wherein x=7, y=3, and z=11. In some embodiments, the SSE compositions comprise from 80 wt % to 99.99 wt % of Li₇P₃S₁₁ nanoparticles. In some embodiments, the SSE compositions comprise from 90 wt % to 99.99 wt % of Li₇P₃S₁₁ nanoparticles. In some embodiments, the SSE compositions comprise from 95 wt % to 99.99 wt % of Li₇P₃S₁₁ nanoparticles. In some embodiments, the SSE compositions comprise from 99 wt % to 99.99 wt % of Li₇P₃S₁₁ nanoparticles.

In some embodiments, the SSE further comprises amorphous materials comprising LiPS. In certain embodiments, the SSE comprises, consists essentially of, or consists of Li₇P₃S₁₁ nanoparticles and an amorphous material. The SSE may comprise LiPS having a formula LiₓP_{y}S_{z}, wherein 3≤x≤7, 1≤y≤3, and 4≤z≤11. In certain embodiments, the SSE comprises from 80 wt % to 99.99 wt % of nanoparticles of Li₇P₃S₁₁ and from 20 wt % to 0.01 wt % amorphous materials. In some embodiments, the SSE comprises from 90 wt % to 99.99 wt % of nanoparticles of Li₇P₃S₁₁ and from 10 wt % to 0.01 wt % amorphous materials. In some embodiments, the SSE comprises from 95 wt % to 99.99 wt % of nanoparticles of Li₇P₃S₁₁ and from 5 wt % to 0.01 wt % amorphous materials. In some embodiments, the SSE comprises from 99 wt % to 99.99 wt % of nanoparticles of Li₇P₃S₁₁ and from 1 wt % to 0.01 wt % amorphous materials.

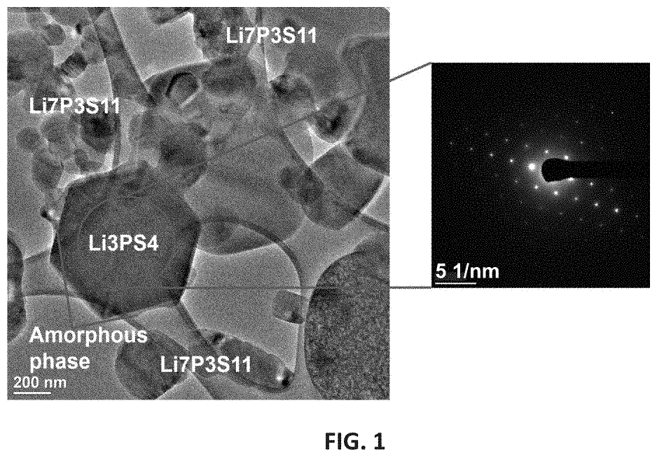

In some embodiments, the SSE further comprises nanoparticles of LiPS with a formula LiₓP_{y}S_{z}, wherein x=3, y=1, and z=4. In certain embodiments, the SSE comprises, consists essentially of, or consists of nanoparticles of Li₇P₃S_{11,} nanoparticles of Li₃PS₄, and amorphous materials. In certain embodiments, as shown in FIG. 1, at least some nanoparticles of Li₃PS₄ are coated with amorphous materials, and nanoparticles of Li₇P₃S₁₁ are not coated with amorphous materials.

### B. Particle Diameter

The SSE may comprise, consist essentially of, or consist of LiPS nanoparticles prepared by the disclosed methods, wherein the nanoparticles have an average diameter of from 50 nm to 1000 nm. Particle diameter may be determined by any suitable method including, but not limited to, scanning electron microscopy. In some embodiments, the LiPS nanoparticles have an average particle diameter of from 100 nm to 1000 nm. In some embodiments, the LiPS nanoparticles have an average particle diameter of from 100 nm to 500 nm. In certain embodiments, the LiPS nanoparticles have an average particle diameter of from 150 nm to 450 nm. In certain embodiments, the LiPS nanoparticles have an average particle diameter of from 100 nm to 120 nm.

In some embodiments, the LiPS nanoparticles comprise irregular shaped particles, plate-like particles, or a mixture thereof. In some embodiments, the plate-like particles comprise hexagonal shaped nanoplates. In some embodiments, the LiPS nanoparticles comprise irregular shaped Li₇P₃S₁₁ nanoparticles. In certain embodiments, the LiPS nanoparticles may further comprise plate-like Li₃PS₄ particles. In certain embodiments, the plate-like Li₃PS₄ particles are hexagonal shaped nanoplates.

In one embodiment, the SSEs are made by embodiments of the disclosed methods, wherein the precursors are 7Li₂S-3P₂S₅, the organic solvent is EA, and the concentration of 7Li₂S-3P₂S₅ in EA is 10 to 20 mg ml⁻¹, the dissolving temperature is from 40 to 60° C., the effective period of time is at least 1 hour, the evaporating temperature is from 80 to 100° C., the heating temperature is 260° C. In such implementations, the SSE may comprise Li₇P₃S₁₁ nanoparticles having an average diameter of from 100 to 500 nm.

In an independent embodiment, the SSEs are made by an embodiment of the disclosed methods, wherein the precursors are 7Li₂S-3P₂S_{5,} the organic solvent is EA, and the concentration of 7Li₂S-3P₂S₅ in EA is 10 mg ml⁻¹, the dissolving temperature is 40 to 60° C., the effective period of time is at least 1 hour, the evaporating temperature is from 80 to 100° C., the heating temperature is 260° C. In such implementations, the SSE may comprise Li₇P₃S₁₁ nanoparticles having an average diameter of 100 nm to 120 nm.

In another independent embodiment, the SSEs are made by an embodiment of the disclosed methods, wherein the precursors are 7Li₂S-3P₂S₅, the organic solvent is EA, and the concentration of 7Li₂S-3P₂S₅ in EA is 20 mg ml⁻¹, the dissolving temperature is from 40 to 60° C., the effective period of time is at least 1 hour, the evaporating temperature is from 80 to 100° C., the heating temperature is 260° C. In such implementations, the SSE may comprise Li₇P₃S₁₁ nanoparticles having an average diameter of from 150 nm to 450 nm.

### C. Li⁺ Conductivity

In some embodiments, the SSEs comprise, consist essentially of, or consist of nanoparticles of LiPS prepared by the disclosed methods, wherein the SSEs exhibit a Li⁺ conductivity of at least 0.7 mS cm⁻¹. In certain embodiments, the SSEs exhibit a Li⁺ conductivity of from 0.7 mS cm⁻¹ to 1.5 mS cm⁻¹, such as from 0.7 mS cm⁻¹ to 1.3 mS cm⁻¹ or from 0.7 mS cm⁻¹ to 1.1 mS cm⁻¹. In some implementations, the SSEs exhibit a Li⁺ conductivity of at least 1.05 mS cm⁻¹.

In one embodiment, the SSEs are made by embodiments of the disclosed methods, wherein the precursors are 7Li₂S-3P₂S₅, the organic solvent is EA, and the concentration of 7Li₂S-3P₂S₅ in EA is 10 to 20 mg ml⁻¹, the dissolving temperature is 40 to 60° C., the effective period of time is at least 1 hour, the evaporating temperature is from 80 to 100° C., the heating temperature is 260° C. In such implementations, the SSE may comprise Li₇P₃S₁₁ nanoparticles having an average diameter of from 100 to 500 nm and/or the SSE may exhibit a Li⁺ conductivity of at least 0.7 mS cm⁻¹.

In an independent embodiment, the SSEs are made by an embodiment of the disclosed methods, wherein the precursors are 7Li₂S-3P₂S₅, the organic solvent is EA, and the concentration of 7Li²S-3P²S⁵ in EA is 10 mg ml⁻¹, the dissolving temperature is from 40 to 60 ° C., the effective period of time is at least 1 hour, the evaporating temperature is from 80 to 100° C., the heating temperature is 260° C. In such implementations, the SSE may comprise Li₇P₃S₁₁ nanoparticles having an average diameter of from 100 to 120 nm and/or the SSE may exhibit a Li⁺ conductivity of at least 0.7 mS cm⁻¹, such as from 0.7 to 1.1 mS cm⁻¹.

In another embodiment, the SSE compositions are made by an embodiment of the disclosed methods, wherein the precursors are 7Li₂S-3P₂S₅, the organic solvent is EA, and the concentration of 7Li₂S-3P₂S₅ in EA is 20 mg ml⁻¹, the dissolving temperature is 40-60° C., the effective period of time is at least 1 hour, the evaporating temperature is from 80 to 100° C., the heating temperature is 260 ° C., and the SSE compositions comprise Li₇P₃S₁₁ nanoparticles having an average diameter of from 150 to 450 nm and/or the SSEs exhibit a Li⁺ conductivity of at least 1.05 mS cm⁻¹, such as from 1.05 to 1.3 mS cm⁻¹.

### D. Electron Conductivity

In some embodiments, the SSEs comprise, consist essentially of, or consist of nanoparticles of LiPS prepared by the disclosed methods, wherein the SSEs exhibit an electron conductivity of from 1×10⁻⁷ to 1×10⁻⁶ mS cm⁻¹, such as 1.5×10⁻⁷ to 3.0×10⁻⁷ mS cm⁻¹, 2×10⁻⁷ to 8×10⁻⁷ mS cm⁻¹, 3×10⁻⁷ to 7×10⁷ mS cm⁻¹, or 4×10⁻⁷ to 6×10⁻⁷ mS cm⁻¹.

In one embodiment, the SSE compositions are made by embodiments of the disclosed methods, wherein the precursors are 7Li₂S-3P₂S₅, the organic solvent is EA, and the concentration of 7Li₂S-3P₂S₅ in EA is from 10 to 20 mg ml⁻¹, the dissolving temperature is from 40 to 60° C., the effective period of time is at least 1 hour, the evaporating temperature is from 80° C. to 100° C., the heating temperature is from 260° C. to 280° C. In such implementations, the SSE may comprise Li₇P₃S₁₁ nanoparticles having an average diameter of 100 nm to 500 nm, the SSEs exhibit a Li+conductivity of at least 0.7 mS cm⁻¹ and exhibit an electron conductivity of from 1.5×10⁻⁷ to 3.0×10⁻⁷ mS cm⁻¹.

In an independent embodiment, the SSEs are made by embodiments of the disclosed methods, wherein the precursors are 7Li₂S-3P₂S₅, the organic solvent is EA, and the concentration of 7Li₂S-3P₂S₅ in EA is 10 mg ml⁻¹, the dissolving temperature is from 40 to 60° C., the effective period of time is at least 1 hour, the evaporating temperature is from 80 to 100° C., the heating temperature is 260° C. In such implementations, the SSE may comprise Li₇P₃S₁₁ nanoparticles having an average diameter of from 100 to 120 nm, the SSEs exhibit a Li⁺ conductivity of at least 0.7 mS cm⁻¹ and exhibit an electron conductivity of 2.1×10⁻⁷ mS cm⁻¹.

Advantageously, SSEs made by embodiments of the disclosed methods are compatible with high voltage cathodes, exhibit high capacity with Li/Na metal anodes, and/or possess high flexibility for cell packing. The nano-sized SSE particles also exhibit enhanced migration of Li⁺ across the active material/SSE interface and/or improve the energy density of ASSLBs with fewer SSE particles.

### IV. Representative Embodiments

Certain representative embodiments are exemplified in the following paragraphs.

A method to prepare a solid state electrolyte comprising nanoparticles of lithium phosphate sulfide comprises: combining a mixture of Li₂S and P₂S₅ having a molar ratio of 7:3 with ethyl acetate to provide a composition comprising 5 to 40 mg ml⁻¹ of the precursors in the ethyl acetate; mixing the composition at a dissolving temperature for an effective period of time to fully dissolve the precursors and form a solution comprising 5 to 40 mg ml⁻¹ of the precursors; evaporating the ethyl acetate at an evaporating temperature to produce a solid composition; and heating the solid composition at a heating temperature from 260° C. to 280° C. for 1 to 3 hours to produce a solid state electrolyte comprising nanoparticles of lithium phosphate sulfide.

The method of the preceding paragraph, wherein the solid composition comprises Li₃PS₄ nanoparticles and an amorphous material having a formula LiₓP_{y}S_{z}, wherein 3≤x≤7, 1≤y≤3, and 4≤z≤11.

The method of either of the preceding paragraphs, wherein the solid state electrolyte comprises nanoparticles of Li₇P₃S₁₁.

The method of any one of the preceding paragraphs, wherein the solid state electrolyte exhibits a Li⁺ conductivity of at least 0.7 mS cm⁻¹.

The method of any one of the preceding paragraphs, wherein the solid state electrolyte exhibits an electron conductivity of from 1×10⁻⁷ to 1×10⁻⁶ mS cm⁻¹. The method of any one of the preceding paragraphs, wherein the effective period of time is at least 1 hour.

The method of any one of the preceding paragraphs, wherein the dissolving temperature is from 40° C. to 60° C.

The method of any one of the preceding paragraphs, wherein the evaporating temperature is from 70° C. to 130° C.

The method of any one of the preceding paragraphs, wherein the nanoparticles have an average diameter of 100-1000 nm.

The method of any one of the preceding paragraphs, wherein the solution comprises from 10 to 20 mg ml⁻¹ of the precursors. A solid state electrolyte prepared by the method of any one of the preceding paragraphs, comprising lithium phosphate sulfide nanoparticles comprising Li₇P₃S₁₁, the lithium phosphate sulfide nanoparticles having an average diameter of from 50 nm to 1000 nm.

The solid state electrolyte of the preceding paragraph, further comprising amorphous lithium phosphate sulfide.

The solid state electrolyte of either of the preceding paragraphs, wherein the solid state electrolyte comprises from 80 wt % to 99.99 wt % of Li₇P₃S₁₁.

The solid state electrolyte of any one of the preceding paragraphs, wherein the solid state electrolyte has a Li⁺ conductivity of at least 0.7 mS cm⁻¹.

The solid state electrolyte of any one of the preceding paragraphs, wherein the solid state electrolyte has a Li⁺ conductivity of from 0.7 mS cm⁻¹ to 1.5 mS cm⁻¹.

The solid state electrolyte of any one of the preceding paragraphs, wherein the lithium phosphate sulfide nanoparticles have an average diameter of from 100 to 1000 nm.

The method of any one of the preceding paragraphs, wherein the solution comprises from 10 mg ml⁻¹ to 20 mg ml⁻¹ of the precursors; the dissolving temperature is from 40° C. to 60° C.; the effective period of time is at least 1 hour; the evaporating temperature is from 80° C. to 100° C.; and the heating temperature is 260° C.

A solid state electrolyte prepared by the method of the preceding paragraph, comprising: lithium phosphate sulfide nanoparticles comprising Li₇P₃S₁₁, the lithium phosphate sulfide nanoparticles having an average particle diameter of from 100 nm to 500 nm.

The solid state electrolyte of the preceding paragraph, wherein: (i) the nanoparticles of lithium phosphate sulfide are prepared from a solution comprising 10 mg ml⁻¹ of the precursors and the nanoparticles have an average particle diameter of from 100 nm to 120 nm; or (ii) the nanoparticles of lithium phosphate sulfide are prepared from a solution comprising 20 mg ml⁻¹ of the precursors and the nanoparticles have an average particle diameter of from 150 nm to 450 nm.

The solid state electrolyte of either of the preceding paragraphs, wherein: (i) the nanoparticles of lithium phosphate sulfide are prepared from a solution comprising 10 mg ml⁻¹ of the precursors and the solid state electrolyte has a Li⁺ conductivity of at least 0.7 mS cm⁻¹; or (ii) the nanoparticles of lithium phosphate sulfide are prepared from a solution comprising 20 mg ml⁻¹ of the precursors and the solid state electrolyte has a Li⁺ conductivity of at least 1.05 mS cm⁻¹.

A method to prepare a solid state electrolyte comprising nanoparticles of lithium phosphate sulfide may comprise: combining a mixture of Li₂S and P₂S₅ having a molar ratio of 3:1 with ethyl acetate to provide a composition comprising 5 to 40 mg ml⁻¹ of the precursors in the ethyl acetate; mixing the composition at a dissolving temperature for an effective period of time to fully dissolve the precursors and form a solution comprising 5 to 40 mg ml⁻¹ of the precursors; evaporating the ethyl acetate at an evaporating temperature to produce a solid composition; and heating the solid composition at a heating temperature from 260° C. to 280° C. for 1 to 3 hours to produce a solid state electrolyte comprising nanoparticles of lithium phosphate sulfide.

A solid state electrolyte prepared by the method of the preceding paragraph, comprising lithium phosphate sulfide nanoparticles comprising Li₃PS₄, the lithium phosphate sulfide nanoparticles having an average diameter of from 50 nm to 500 nm, and the solid state electrolyte having a Li+conductivity of at least 0.1 mS cm⁻¹.

### V. EXAMPLES

### General Methods

### Synthesis of Lithium Phosphate Sulfide Solid State Electrolyte

All chemicals were purchased from Sigma-Aldrich (St. Louis, Mo.) and used directly without further treatment. In a typical synthesis procedure, a mixture of hand-milled commercial Li2S: P2S5 with a molar ratio of 7:3 was loaded into EA at 10 mg ml⁻¹. The suspension was heated at 50 ° C. and gradually transformed into a transparent liquid after stirring over 2 h. After that, the obtained transparent liquid was heated at 100° C. to gradually evaporate EA solvent, and white solid compositions were collected. Finally, Li₇P₃S₁₁ nanoparticles were obtained by heating the white solid compositions in a sealed autoclave at 260° C. for 1 h. To control the morphology of Li₇P₃S₁₁ SSEs, different concentrations of Li₂S: P₂S₅ (7:3, solutes, 20, 40 mg ml⁻¹) in EA and evaporation temperature (80 and 150° C.) were adapted with the same operation procedures described above.

### Characterizations

The morphology of the samples was characterized by using FEI Helios NanoLab™ 600i (FEI, Hillsboro, OR) with an acceleration voltage of 5 kV. The chemical composition of samples was analyzed by Energy-dispersive X-ray spectroscopy (EDS) mapping with an Oxford X-Max 80 EDS detector (Oxford Instruments Analytical Ltd., Concord, Mass.), Raman spectroscopy with Horiba LabRAM HR spectrometer (Horiba, Edison, N.J.) and Nikon Ti-E inverted optical microscope with a 40x objective and a 632.8 nm HeNe laser light source (Nikon Instruments Inc., Melville, N.Y.), and Fourier-transform infrared spectroscopy (FT-IR, ALPHA II), scanned in the ranges of from 400 to 4000 cm⁻¹ (Bruker, Billerica, Mass.). The phases of samples were examined by powder X-ray diffraction (XRD, Rigaku D/Max Rapid™ II micro-diffraction system with a rotating Cr target, λ=2.2910 Å, operated at 35 kV and 25 mA) (Rigaku Corp., The Woodlands, Tex.). In situ variable temperature (23-500° C.) XRD analysis of the sample was conducted with a Bruker D8 Discover diffractometer equipped with a Vantec 500 area detector and a rotating Cu anode (Kαλ=1.5418 Å) (Bruker, Billerica, Mass.), capable of producing an intensely focused 0.5 mm beam. The sample was loaded into a 0.8 mm diameter and thin-walled (˜0.01 mm) borosilicate capillary (Charles Supper Co., Westborough, Mass.) in a Nz glovebox, sealed with epoxy, and placed into a Ti sample holder slit with an internal cartridge heater. The capillary heating setup was mounted in the XRD on a custom-built programmable XYZ stage and positioned using a laser-video alignment system. A Vantec-500 area detector system positioned at 26 °2θ with a measured sample-detector distance of 15 cm was used to capture diffraction images. For all 200 second scans, the power settings were 50 kV and 24 mA and the sample had a vertical oscillation of 1.0 mm. Initially, images were processed with Bruker-AXS General Area Detector Diffraction System (GADDS) software (Bruker, Billerica, Mass.) before importing into MDI JADE® XRD software (Material Data, Inc., Livermore, Calif.). Coupled thermogravimetric and mass spectrometry (TGA-MS) analyses were performed with a Netzsch Instruments TG-209F1 thermogravimetric analyzer connected to a QMS 403 C Aeolos quadrupole mass spectrometer (Netzsch, Burlington, Mass.). Samples were subjected to TGA-MS to monitor sample weight changes during thermal decomposition in an inert atmosphere were measured with a precision microbalance, while decomposition products were monitored by observing selected ion currents (m/z), respectively. Each sample was heated in an alumina crucible at 5° C/min to 400° C. under 11 ml/min Nz flow. To minimize odor and sample reactivity during sample transfer from vial to crucible, crucible loading, and closure of the TG sample chamber, the TG unit was encased in a temporary glove bag sparged with flowing Nz. NMR single-pulse and pulsed-field gradient (PFG) diffusion measurements were performed on a Varian DDRS spectrometer (Varian, Palo Alto, CA) with a 17.6 T magnet (corresponding to 748.07 MHz for ¹H, 290.70 MHz for ⁷Li, 302.81 MHz for ³¹P, and 188.11 MHz for ¹³C) using a broad-band (BBO) probe. The 90° pulse widths were 13 μs for ¹H, 20 μs for ⁷Li, 15 μs for ³¹P and 16 μs for ¹³C. D1 array was used to make sure ³¹P spectra were fully relaxed and π/20 pulse was used for ⁷Li with a relaxation delay of 1 s for quantitative analysis. ³¹P and ¹³C diffusion coefficients were measured using bipolar pulse pair stimulated echo pulse sequence with convection compensation, while ⁷Li diffusion used gradient compensated stimulated echo pulse sequence. The typical parameters for diffusion ordered spectroscopy (DOSY) experiments were gradient g=1.6−50 G/cm, number of increments=24, diffusion gradient duration δ=2−4 ms, diffusion delay Δ=50−200 ms, gradient stabilization delay=2 ms, number of scans=32, number of scans for steady state=16. ⁷Li, ³¹P and ¹³C chemical shifts were referenced to 1 M LiCl in D₂O at 0 ppm, 85% H₃PO₄ at 0 ppm, and DMSO-d₆ at 39.5 ppm, respectively.

### The Ion Conductivity and Electrochemical Performance Measurement

The room temperature ion conductivity was tested with electrochemical impedance spectroscopy (EIS) on an electrochemical workstation (CHI, 660E) (CH Instruments, Inc., Austin, Tex.) with the frequency range from 1 MHz to 1 Hz. In a typical test procedure, a certain amount of sample was pelletized by cold pressing in a 13 mm diameter PEEK die at 400 MPa with two stainless steel rods for the measurements. To assemble the Li/Li₇P₃S₁₁/Li symmetric cell, 0.1 g of sample was firstly cold pressed at 350 MPa with two stainless steel rods in a Swagelok. And then two slides of Li metal foils were attached in both sides at 125 MPa for the cycling test at room temperature. The area capacity and current density were set at 0.5 mAh cm⁻² and 0.1 mA cm⁻² respectively.

### Example 1

### Synthesis of LiPS SSEs using Different Solvents

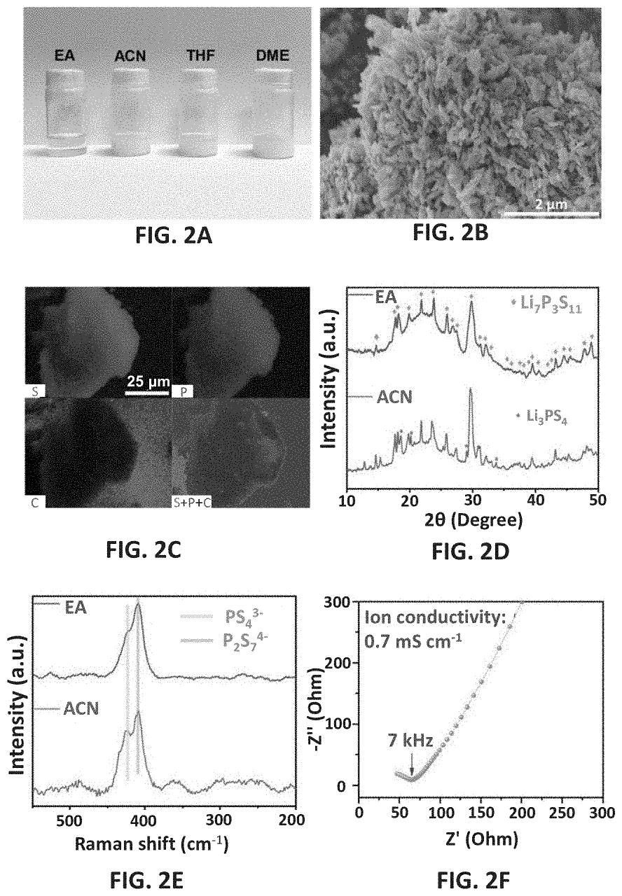

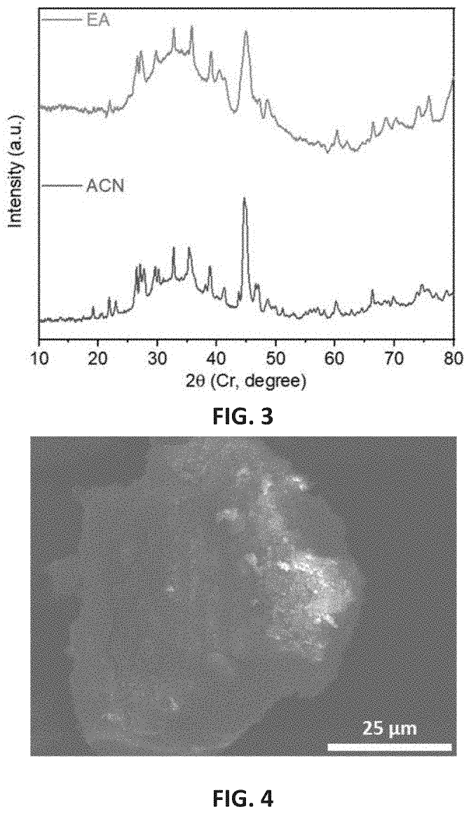

A mixture of commercial Li₂S/P₂S₅ with a molar ratio of 7:3 was loaded into EA at 10 mg ml⁻¹. The obtained suspension was heated at 50° C. and gradually transformed into a transparent liquid after stirring over 2 h, as shown in FIG. 2. After the evaporation of EA at 100° C., white solid compositions were collected and the Li₇P₃S₁₁ nanoparticles were obtained by heating the white solid compositions in a sealed autoclave at 260° C. for 1 h.

To elucidate the solvation ability of EA toward the mixture of 7Li₂S-3P₂S₅, three other samples were also prepared by using the same components but different solvents that were generally applied to synthesize Li₇P₃S₁₁, including ACN, THF and DME. A large amount of solids remained suspended in ACN, THF and DME solutions even after stirring over 3 days at 50° C. (FIG. 2A), implying their poor solvation abilities. Only EA provided a homogeneous solution with 7Li₂S-3P₂S₅.

To confirm the chemical components, SEM energy dispersive EDS was conducted. The EDS mapping images (FIG. 2C) illustrate the uniform distribution of P and S in the samples. Carbon was detected around the samples because a conductive tape was used to fix samples for SEM imaging.

The absence of carbon in the sample area indicates that almost all EA solvent was removed during the heating processes. The corresponding SEM image for EDS mapping is shown in FIG. 4.

To further study the structure and compositions of the as-synthetic samples, XRD and Raman spectra were performed. FIG. 2D shows the XRD patterns of the samples synthesized by using EA (red) and ACN (purple) solvents.

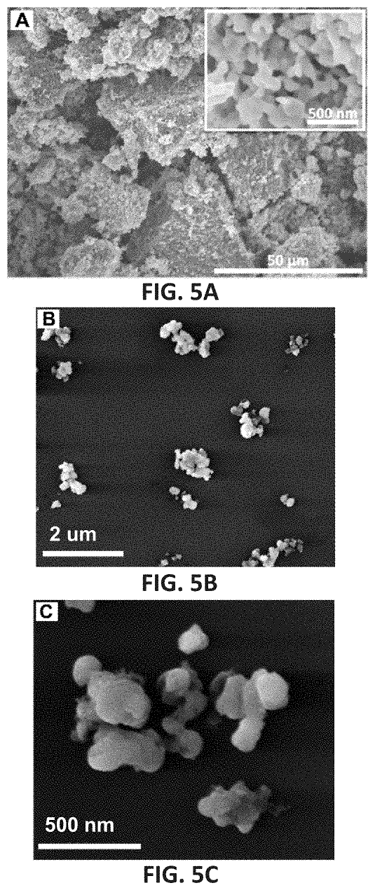

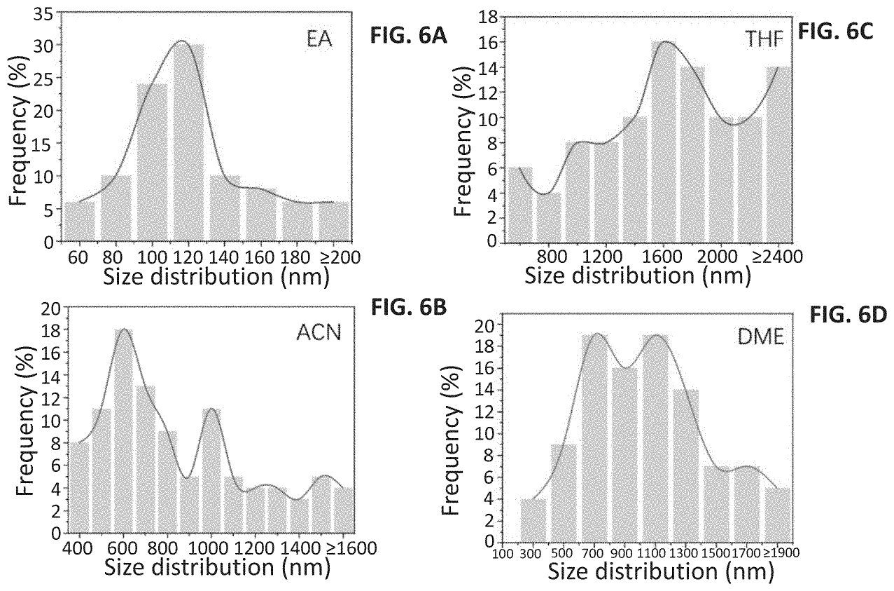

The Raman spectra of Li₇P₃S₁₁ samples synthesized from EA and ACN shown in FIG. 2E reveal two peaks centered at 410 and 426 cm⁻¹, which can be assigned to the typical local structural unit of P₂S₇⁴⁻ and Ps₄³⁻ in Li₇P₃S₁₁ respectively. Compared to EA, the Li₇P₃S₁₁ from ACN exhibited a relatively higher intensity ratio at 426 cm⁻¹ peak with the residual β-Li₃PS₄ present. Scanning electron microscopy (SEM) was employed to evaluate the particle diameter of samples prepared by using EA solvent. FIG. 2B shows the typical SEM image of the as-synthetic samples, which were composed of uniform nanoparticles with a narrow size distribution centered at around 110 nm (FIG. 5 and FIG. 6A).

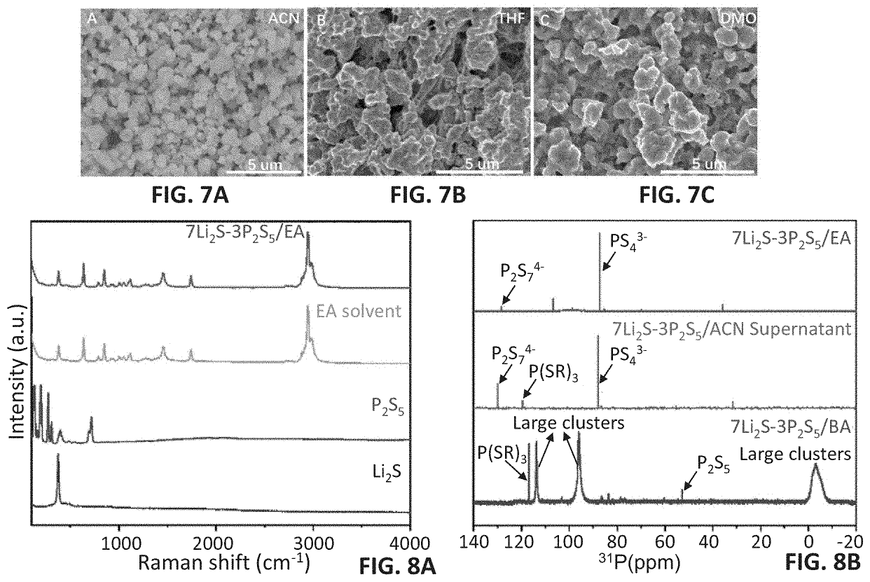

XRD and Raman spectra were performed. FIG. 2D shows the XRD patterns of the samples synthesized by using EA (red) and ACN (purple) solvents. The broadened full width at half maximum peaks in Li₇P₃S₁₁ via EA indicated a smaller particle size compared with ACN, mirroring the results from their SEM images (FIG. 2B, FIG. 6B and 7A).

Moreover, Li₇P₃S₁₁ samples synthesized with EA solvent also exhibited the much narrower size distribution range and smaller particle sizes even compared to these with THF (FIG. 6C, 7B) and DME solvent (FIG. 6D and 7C).

The ionic conductivity of the nanosized Li₇P₃S₁₁ particles synthesized by EA solvent was measured by electrochemical impedance spectroscopy. As shown in FIG. 2F, SSEs comprising Li₇P₃S₁₁ nanoparticles exhibited a room temperature Li⁺ conductivity of 0.7 mS cm⁻¹, which shows great potential for future applications.

### Example 2

### Solvation of 7Li₂S-3P₂S₅ in Different Solutions

The solvation mechanism of 7Li₂S-3P₂S₅ in EA solvent and the reaction mechanism during the evaporation and heating processes is useful for understanding the formation of Li₇P₃S₁₁ nanoparticles and to control the particle size. To identify the solvation mechanism and the reaction mechanism, a mixture of commercial Li₂S/P₂S₅ with a molar ratio of 7:3 was loaded into EA at 10 mg ml⁻¹. The obtained suspension was heated at 50° C. and gradually transforms into a transparent liquid after stirring over 2 h to generate mixture of 7Li₂S-3P₂S₅/EA.

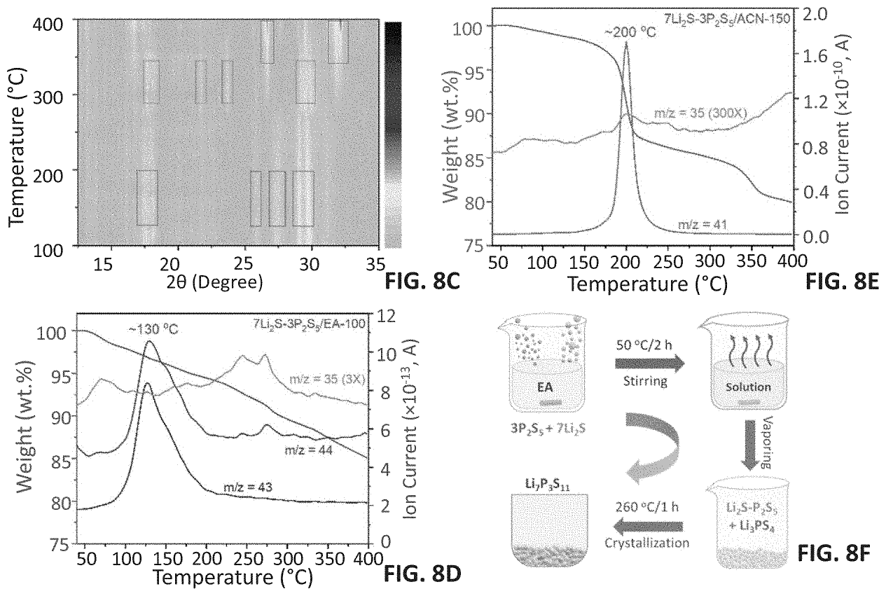

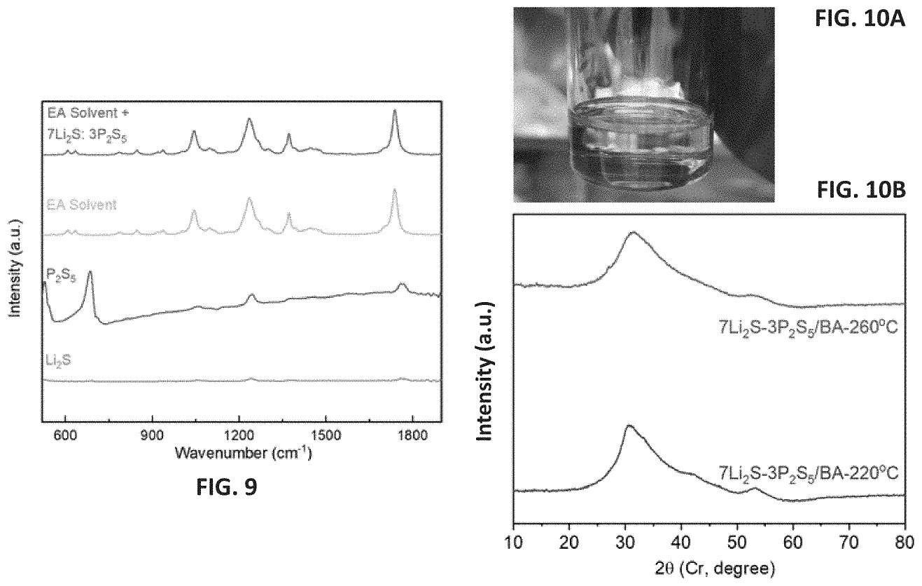

Raman and FT-IR spectra were performed to analyze samples of Li₂S, P₂S₅, EA solvent and mixture of 7Li₂S-3P₂S₅/EA. FIG. 8A shows Raman spectra of Li₂S, P₂S₅, EA and the mixture of 7Li₂S-3P₂S₅/EA, in which each of Li₂S, P₂S₅ and EA Raman spectrum revealed their distinct Raman peaks. However, the transparent 7Li₂S-3P₂S₅/EA solution illustrated almost the same Raman curve as pure EA solvent without the appearance of typical peaks from solid Li₂S and P₂S₅, implying that the bond breaking of Li₂S and P₂S₅ was promoted by EA solvent. Moreover, the corresponding FT-IR spectra of the four samples (FIG. 9) also exhibited a similar trend. It's normal to observe the disappearance of Raman and FT-IR peaks of sulfide based solutes after the formation of homogeneous solutions with an organic solvent. In this regard, both Raman and FT-IR spectra have identified the formation of soluble intermediates by full solvation of 7Li₂S-3P₂S₅ in EA solution.

To further understand the solvation mechanism of 7Li₂S-3P₂S₅ in different solvents, 7Li₂S-3P₂S₅ was dissolved in γ-butyrolactone (BA) to produce 7Li₂S-3P₂S₅/BA solution. Full solvation of 7Li₂S-3P₂S₅ without precipitation doesn't necessarily suggest a feasible way to prepare Li₇P₃S₁₁ nanoparticle, because BA was also found to be a good solvent to fully dissolve 7Li₂S-3P₂S₅, but without Li₇P₃S₁₁ produced after evaporation and heating treatment (FIG. 10). Therefore, without wishing to be bound by a particular theory of operation, it may be associated with their varied solvation structures of 7Li₂S-3P₂S₅ in varied solvents.

The ⁷Li, ³¹P single-pulse NMR and PFG diffusion NMR were further applied to understand the solvation structures of 7Li₂S-3P₂S₅ in different solutions.

FIG. 8B presents the ³¹P NMR spectra of 7Li₂S-3P₂S₅/EA, the supernatant of 7Li₂S-3P₂S₅/ACN and 7Li₂S-3P₂S₅/BA. The dominant species in the first two solutions was PS₄³⁻ located at 88 ppm, which contributes to 50% in EA and 65% in ACN, and another ionic bonded species P₂S₇⁴⁻at 130 ppm was also found in both solutions (3% in EA and 14% in ACN). A small amount of covalently bonded species P(SR)3 was present in ACN (5%), while the second abundant species in EA was a resonance at 108 ppm (29%), which may be attributed to some thiophosphate species that contains a mixture of ionic bonded and covalently bonded (P—S—C) groups. However, 7Li₂S-3P₂S₅/BA exhibits distinct solvation structures from the other two samples. With only 1% P54³⁻, 1% P(SR)₃ and 1% unreacted P255, the main resonances centered at 116 ppm, 98 ppm, and −1 ppm that contribute to 13%, 34% and 50%, respectively, were much broader than other soluble thiophosphate species.

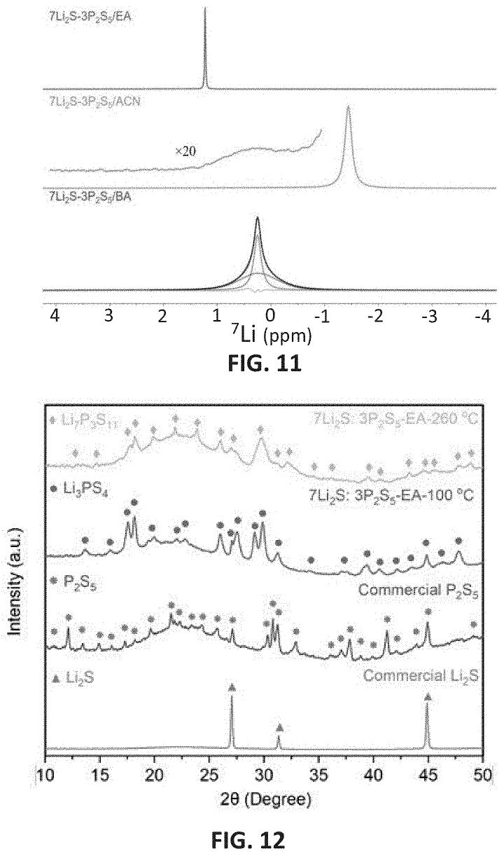

Meanwhile, ⁷Li NMR exhibited a single sharp resonance in EA but two broader peaks in ACN and BA (FIG. 11, Table 1). Furthermore, the self-diffusion coefficients of Li⁺, thiophosphate species and solvents (Table 2 and 3) measured using PFG ⁷Li, ³¹P and ¹³C NMR, respectively, confirmed that Li⁺ in EA and the major species in ACN were well-solvated by the solvents, while Li⁺ in BA may form a larger cluster with thiophosphate. According to the Stokes-Einstein equation, diffusion coefficient D is inversely proportional to the particle radius r, so D₁/D₂=r₂/r₁. Table 2 gives the ratio of diffusion coefficient of solvent D(s) to that of Li⁺ and thiophosphate species; therefore, a rough estimation of the size of hydrodynamic radius of these species can be made. The hydrodynamic radius of PS₄³⁻, P(SR)₃ and Li⁺ in EA and ACN were around 3 to 4 times of the solvent, indicating that Li⁺ was well-solvated in these solutions coordinating to 3 or 4 solvent molecules. In contrast, the species with the broad ³¹ P peaks at 116 and 98 ppm (P1 and P2) and Li⁺ have much larger hydrodynamic radius (11 to 14 times the size of BA), so it is reasonable to assume that these species were present as one or a few large clusters.)

Moreover, attempts were made to dissolve single part of Li₂S or P₂S₅ at the same concentrations in 7Li₂S-3P₂S₅, but neither of them could be dissolved in EA solutions. Therefore, it is concluded that EA possesses a very strong solvation ability toward the 7Li₂S-3P₂S₅ mixture, but not the individual precursors, by the full solvation of Li⁺, PS₄³⁻ and thiophosphate-based groups, which make it possible to control the nucleation and crystal growth rates.

TABLE 1
⁷Li NMR chemical shift, line width and molar fraction
of each species in the three solutions

| | Δ(⁷Li) (ppm) | Line width (Hz) | mol fraction (%) |
|---|---|---|---|
| EA | 1.25 | 5.7 | 100 |
| ACN | 0.40 | 381.9 | 4.2 |
| ACN | −1.40 | 43.3 | 95.8 |
| BA | 0.23 | 247.2 | 57.0 |
| BA | 0.25 | 46.7 | 43.0 |

TABLE 2
Diffusion coefficients (×10⁻¹⁰ m²/s) of solvent, Li⁺ and thiophosphate
species measured using PFG ¹³C, ⁷Li, ³¹P NMR, respectively, at 25° C.

| | | | | | D (P1 at | D (P2 at |
|---|---|---|---|---|---|---|
| Solvent | D(solvent) | D(Li⁺) | D(PS₄³⁻) | D(P(SR)₃) | 116 ppm) | 98 ppm) |
| EA | 22.6 | 6.0 | 5.9 | | | |
| ACN | 38.6 | 13.7 | 10.5 | | | |
| BA | 4.6 | 0.4 | | 1.7 | 0.33 | 0.37 |

TABLE 3
The ratio of solvent diffusion coefficient to Li⁺ and
thiophosphate species reveals the size ratio between clusters

| | D(s)/ | D(s)/ | D(s)/ | D(s)/ | D(s)/ |
|---|---|---|---|---|---|
| Solvent | D(Li⁺) | D(PS₄³⁻) | D(P(SR)₃) | D(P1) | D(P2) |
| EA | 3.8 | 3.8 | | | |
| ACN | 2.8 | 3.7 | | | |
| BA | 11.5 | | 2.7 | 13.9 | 12.4 |

### Example 3

### Evolution of Chemical Components during Heat Treatment from 100° C. to 400° C.

A mixture of commercial Li₂S/P₂S₅ with a molar ratio of 7:3 was loaded into EA at 10 mg ml⁻¹. The obtained suspension was heated at 50° C. and gradually transformed into a transparent liquid after stirring over 2 h to generate mixture of 7Li₂S-3P₂S₅/EA. After the evaporation of EA at 100° C., intermediates in the form of white solid compositions were collected.

To examine the intermediates after fully evaporating EA at 100° C. (7Li₂S-3P₂S₅/EA-100), XRD was performed. As shown in FIG. 12, 7Li₂S-3P₂S₅/EA-100 revealed a pure crystalline phase of β-Li₃PS₄ based on the visible diffraction peaks. After heating at 260° C. for 1 h, 7Li₂S-3P₂S₅/EA-100 was fully converted into the pure phase of Li₇P₃S₁₁ (7Li₂S-3P₂S₅/EA-260). Besides, the phases of Li₂S and P₂S₅ were not observed after their initial dissolution with EA. Therefore, without wishing to be bound by a particular theory of operation, the formation of Li₇P₃S₁₁ may be resulted from the crystalline Li₃PS₄ and the amorphous materials in the intermediates, which may be explained by the amorphous LiPS materials coated on the Li₃PS₄. In the disclosed examples, the precipitated Li₃PS₄ resulted from continuous evaporation of EA solvent. The highly concentrated solutions are expected to lead to the nucleation of Li₃PS₄ nanoparticles without solvent bonding and finally the amorphous materials are expected to separate upon the drying of solvent and coat on the surface of crystalline nanoparticles.

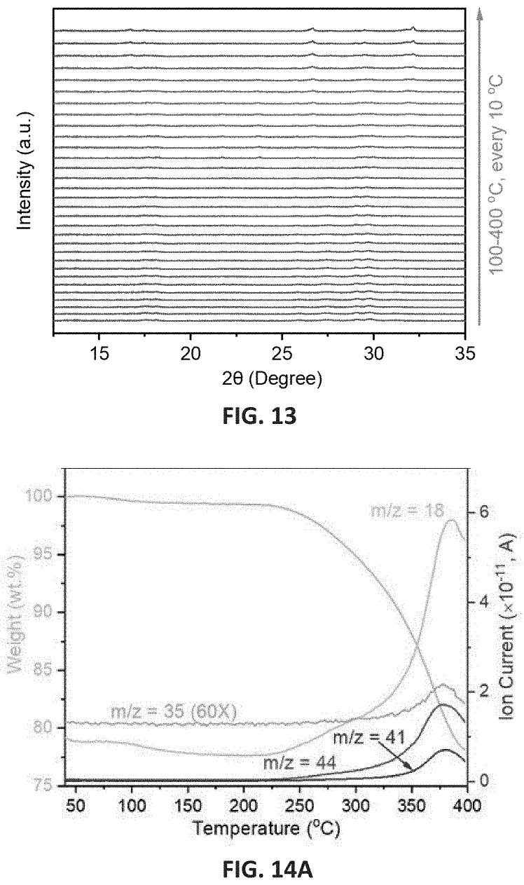

In light of the phase transformation during the heat treatment, in-situ heating XRD was applied to specifically monitor this procedure. FIG. 8C and FIG. 13 illustrates the in-situ XRD contour plots from the patterns collected every 10° C. from 100° C. to 400° C. As depicted, the diffraction peaks of β-Li₃PS₄ (Blue box) maintained their stability below 250° C., but gradually weakened and disappeared from 260 to 270° C. At the same time, new diffraction peaks assigned to Li₇P₃S₁₁ (Red box) gradually increased in intensity and became dominant in the patterns, matching well with the phase transformation temperature of Li₇P₃S₁₁ in previous literature. However, the peaks from Li4P2S6 (Green box), as a low Li⁺ conductor, appeared quickly especially when the temperature was increased over 300° C. And finally, Li₄P₂S₆ became the main product after heating to 350 ° C., suggesting the metastable and temperature-dependent essence of Li₇P₃S₁₁.

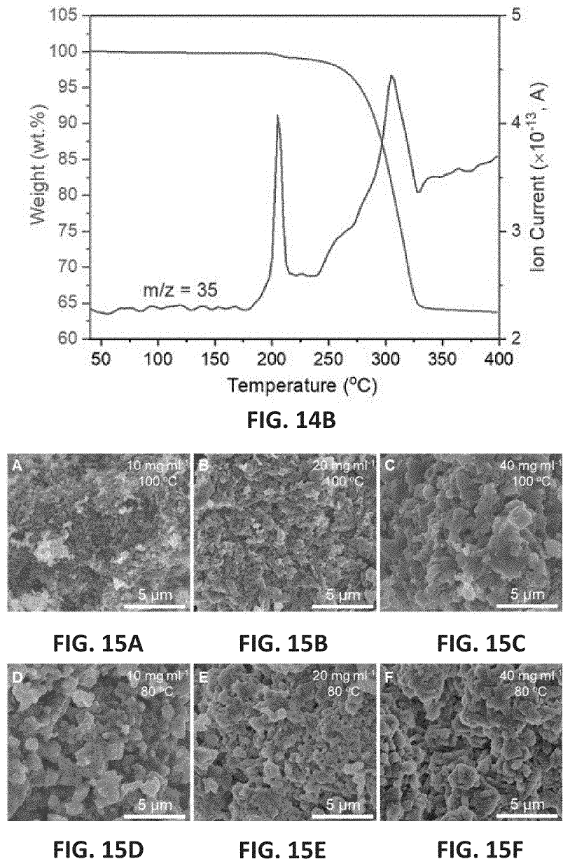

In addition to in-situ variable temperature XRD, TGA-MS was also applied to further understand the evolution of chemical components during heating. As shown in FIG. 8D, 7Li₂S-3P₂S₅/EA-100 experienced apparent weight losses at around 70 and 130° C., which were estimated to be 1.3 and 4.4 wt. % respectively after stabilization. The former weight loss at 70° C. was associated with absorbed species in the glove box, such as N₂, or adsorbed EA solvent. The weight loss at 130° C. can be attributed to the residual bonded EA solvent in the samples, because the species m/z=43 and 44 represent the typical thermal decomposition products of EA according to the standard EA mass spectrum (NIST MS: 19528). However, 7Li₂S-3P₂S₅/ACN-150 revealed a weight loss of 8.6 wt. % around 200° C. that resulted from the loss of residual ACN molecular (m/z=41, NIST MS: 228221), nearly 2 times of the EA residual. Moreover, the higher evaporation temperature of ACN residual compared to EA indicates a much lower bonding energy between EA and solutes. As for BA solvent, the residual solvent is expected to be completely evaporated around 380° C. (FIG. 14A), which suggests the strong binding between BA solvent and solutes and explains why Li₇P₃S₁₁ cannot be obtained at 260° C. It's worth pointing out that additional m/z=35 species can be observed in the TGA-MS curves of EA, ACN, BA and simply mixed 7Li₂S-3P₂S₅ based samples (FIG. 8D, 8E, and 14). This was assigned to evaporated sulfur-based species because of the intrinsic instability of the Li₂S-P₂S₅ mixture at elevated temperature and the main reason to cause the formation of impurities such as Li₄P₂S₆. Therefore, choosing the suitable solvent with low bonding energy to synthesize Li₇P₃S₁₁ is very important.

Based on the above results, a likely growth mechanism of Li₇P₃S₁₁ nanoparticles in the disclosed wet chemical procedures is depicted in FIG. 8F. When the mixture of 7Li₂S-3P₂S₅ was firstly loaded in EA solvent, they were completely solvated into Li⁺, PS₄³⁻ and other thiophosphate species without any precipitation under stirring at 50° C. During the evaporation processes at 100° C., Li₃PS₄ nanoparticles gradually precipitated from the solution. Finally, some amorphous materials coated on the surface of Li₃PS₄ nanoparticles, both of which contributed to the formation of Li₇P₃S₁₁ at the appropriate temperature (260° C.).

### Example 4

### The Effect of Precursors Concentration and Evaporation Temperature on the Size of Nanoparticles

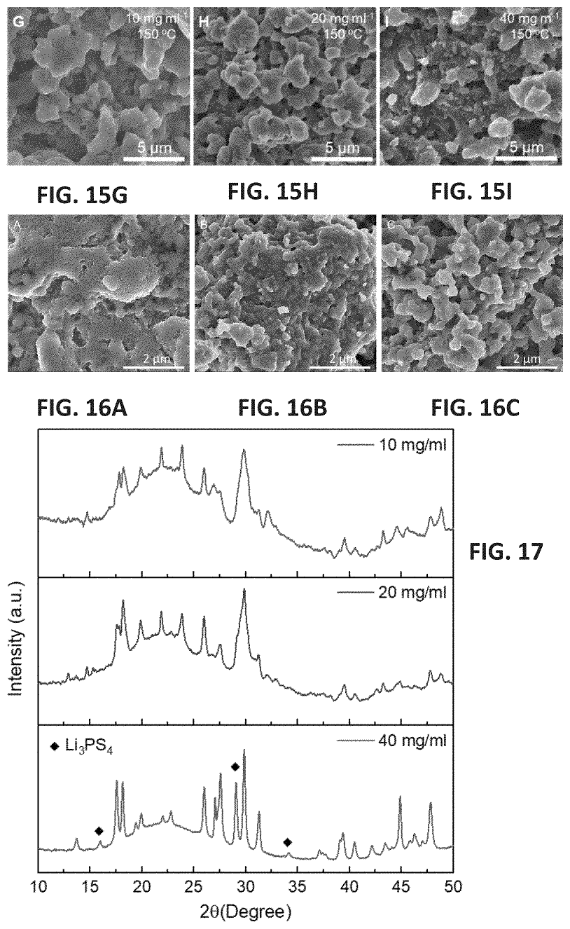

Size manipulation is important for the practical application of Li₇P₃S₁₁ particularly toward reducing the SSE content and cathode/SSEs interfacial resistance. To understand the effect of precursors concentration and evaporation temperature on the size of nanoparticles, a series of experiments were performed. As shown in FIG. 15, samples were labelled with their corresponding concentrations and evaporation temperatures.

The effect of precursors concentration on the diameter of nanoparticles The concentration effect was firstly studied with three concentration levels and fixed evaporation temperature at 100° C., including 10, 20, and 40 mg ml⁻¹ of 7Li₂S-3P₂S₅ precursors (FIGS. 15 A-C).

Interestingly, the diameter of nanoparticles increased from ˜110 nm to ˜300 nm and further to >1 μm with increasing concentrations from 10 to 40 mg ml⁻¹. Moreover, the SEM images of 7Li₂S-3P₂S₅/EA-100 prepared at concentrations of 10, 20 and 40 mg ml⁻¹ (FIG. 16) illustrate that the primary particle diameter after solvent evaporation is highly dependent on the concentrations of precursors too and match well with the Li₃PS₄ template directed growth mechanism. The effect of evaporation temperature on the diameter of nanoparticles

The effect of evaporation temperature was studied with three temperatures (80° C., 100° C., and 150° C.) and the same concentrations of precursors, as displayed in FIGS. 15 D-1. Under varied concentrations, the products showed the largest diameters (2˜5 μm) at 150° C. (FIGS. 15 G-I). At the temperature of 80° C. (FIGS. 15 D-F), products exhibited smaller average diameters than those collected at 150° C.; however, they still had significantly larger particle diameters than those at 100° C.

This phenomenon was associated with the evaporation speed of solvents, as a lower temperature triggering a slower evaporation speed and a longer time for crystal growth. The nucleation sizes of Li₃PS₄ don't necessarily decrease with a lower evaporation temperature, because there is competition between nucleation and crystal growth, and also between different crystals during the growth processes.

In this regard, 10 mg ml⁻¹ and 100° C. are the preferred experimental parameters for preparing ideal small sized Li₇P₃S₁₁ nanoparticles.

### Example 5

### The Effect of Precursors Concentration and Evaporation Temperature on Ion and Electronic Conductivity

To understand the effect of precursors concentration and evaporation temperature on ion and electronic conductivity of nanoparticles, a series of experiments was performed.

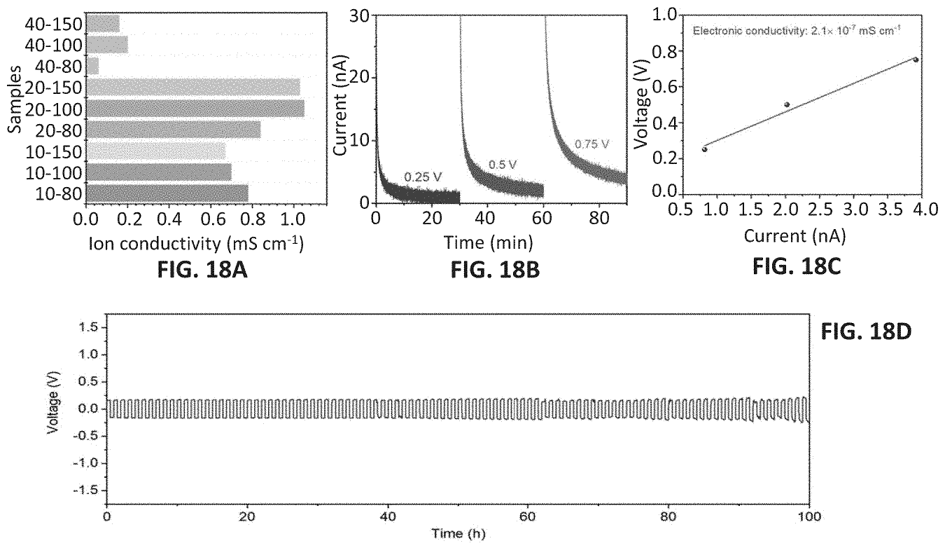

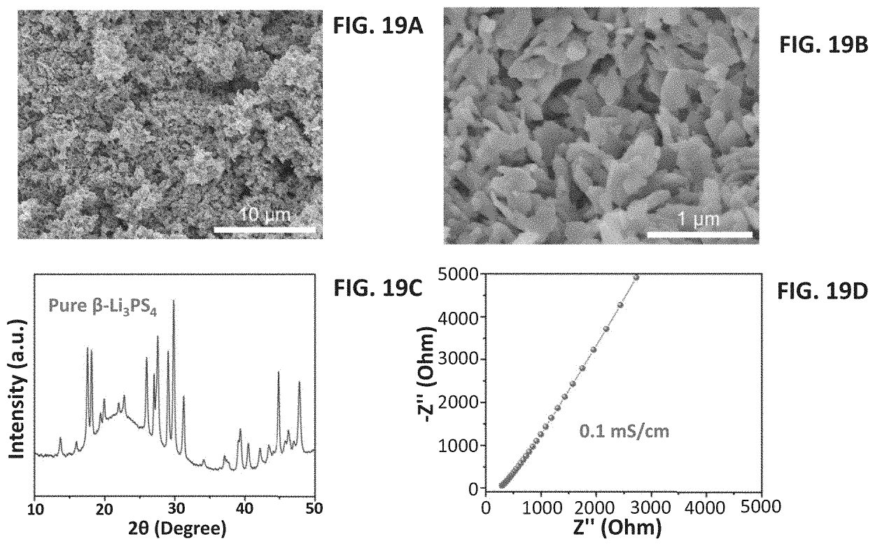

FIG. 18A presents the Li⁺ conductivities of Li₇P₃S₁₁ samples prepared at varying concentrations and evaporation temperatures shown in FIG. 15. As depicted, the samples prepared at the same concentration but different evaporation temperatures exhibited similar ion conductivities, but varied concentrations significantly affected their corresponding ion conductivities. The highest ion conductivity (1.05 mS cm⁻¹) was achieved at 20 mg ml⁻¹ with an evaporation temperature of 100 ° C. Based on these results, the ion conductivities do not depend on their sizes but on the concentrations.

To further investigate reasons for the concentration effect on their varied Li⁺ conductivity, the XRD patterns of 40 mg ml⁻¹−100° C., 20 mg ml⁻¹−100° C. and 10 mg ml⁻¹−100° C. samples were examined (FIG. 17). The impurity peaks ascribed to Li₃PS₄ presented in the XRD pattern when the concentration increased to 40 mg ml⁻¹. Because of the higher concentrations, it's more challenge to uniformly disperse the Li₃PS₄ nanoparticles that are expected to cause the impurity residual in final products and the decrease of Li⁺ conductivity. For samples obtained at the 20 and 10 mg ml⁻¹, they showed the similar level of Li⁺ conductivities even though 20 mg ml⁻¹ was still slightly better than 10 mg ml⁻¹. The average sizes of samples from 20 mg ml⁻¹ were slightly larger than 10 mg ml⁻¹, which indicated the less grain boundaries for Li⁺ diffusion between particles from 20 mg ml⁻¹ and contributed to improve the ion conductivities.

The electronic conductivity of SSEs is another important parameter for their practical application. The smallest size of Li₇P₃S₁₁ sample prepared at 10 mg ml⁻¹, 100° C. was used as an example and applied constant voltages of 0.25, 0.5 and 0.75 V for each pulse over 30 min to stabilize the current (FIG. 18B). The electronic conductivity was calculated as 2.1×10⁻⁷ mS cm⁻¹ (FIG. 18C), suggesting excellent electron insulator performance. To better examine the practical application, a Li/Li₇P₃S₁₁/Li symmetric cell was assembled and cycled at a constant current density of 0.1 mA cm⁻² (FIG. 18D). The Li symmetric cell illustrated that it can be stably cycled over 100 hours without an apparent increase of overpotentials or short circuits.

Advantageously, the disclosed synthesis methods have been used to synthesize Li₃PS₄, which is another vital sulfide-based electrolyte for ASSLBs. FIG. 19 shows the Li₃PS₄ nanoparticles synthesized from a 10 mg ml⁻¹ solution after evaporation at 100° C. The precursors comprise a mixture of Li₂S and P₂S₅ with a molar ratio of 3:1. From the large scale SEM image (FIG. 19A), the nanoparticles exhibited uniform size with the absence of micro-sized materials. The magnified SEM image of the sample (FIG. 19B) displays an average size of 200 nm. The XRD pattern (FIG. 19C) suggests a pure β phase of Li₃PS₄. Compared to previous reported micro-size Li₃PS₄ particles, the samples prepared by the disclosed methods showed significant advantages for size manipulation. A room temperature ion conductivity of 0.1 mS cm⁻¹ (FIG. 19D) was obtained from the EIS curve of the Li₃PS₄ nanoparticles.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
preparing a solid state electrolyte comprising nanoparticles of lithium phosphate sulfide by
combining precursors comprising Li₂S and P₂S₅ having a molar ratio of 7:3 with ethyl acetate to provide a composition comprising 5 to 40 mg ml⁻¹ of the precursors in the ethyl acetate;
mixing the composition at a dissolving temperature for an effective period of time to fully dissolve the precursors and form a solution comprising 5 to 40 mg ml⁻¹ of the precursors;
evaporating the ethyl acetate at an evaporating temperature to produce a solid composition; and
heating the solid composition at a heating temperature from 260° C. to 280° C. for 1 to 3 hours to produce a solid state electrolyte comprising nanoparticles of lithium phosphate sulfide.

2. The method of claim 1, wherein the solid composition comprises Li₃PS₄ nanoparticles and an amorphous material having a formula LiₓP_{y}S_{z}, wherein 3≤x≤7, 1≤y≤3, and 4≤z≤11.

3. The method of claim 1, wherein the solid state electrolyte comprises nanoparticles of Li₇P₃S₁₁.

4. The method of claim 1, wherein the solid state electrolyte exhibits a Li⁺ conductivity of at least 0.7 mS cm⁻¹.

5. The method of claim 1, wherein the solid state electrolyte exhibits an electron conductivity of from 1×10⁻⁷ to 1×10⁻⁶ mS cm⁻¹.

6. The method of claim 1, wherein the effective period of time is at least 1 hour.

7. The method of claim 1, wherein the dissolving temperature is from 40° C. to 60° C.

8. The method of claim 1, wherein the evaporating temperature is from 70° C. to 130° C.

9. The method of claim 1, wherein the nanoparticles have an average size of from 50 nm to 1000 nm.

10. The method of claim 1, wherein the solution comprises from 10 to 20 mg ml⁻¹ of the precursors.

11. The method of claim 1, wherein:
the solution comprises from 10 mg ml⁻¹ to 20 mg ml⁻¹ of the precursors;
the dissolving temperature is from 40° C. to 60° C.;
the effective period of time is at least 1 hour;
the evaporating temperature is from 80° C. to 100° C.; and
the heating temperature is 260° C.

12. A solid state electrolyte prepared by the method of claim 1, comprising lithium phosphate sulfide nanoparticles comprising Li₇P₃S₁₁, the lithium phosphate sulfide nanoparticles having an average size of from 50 nm to 1000 nm.

13. The solid state electrolyte of claim 12, wherein the lithium phosphate sulfide nanoparticles have an average size of from 100 nm to 1000 nm.

14. The solid state electrolyte of claim 12, further comprising amorphous lithium phosphate sulfide.

15. The solid state electrolyte of claim 12, wherein the solid state electrolyte comprises from 80 wt % to 99.99 wt % of Li₇P₃S₁₁.

16. The solid state electrolyte of claim 12, wherein the solid state electrolyte has a Li⁺ conductivity of at least 0.7 mS cm⁻¹.

17. The solid state electrolyte of claim 12, wherein the solid state electrolyte has a Li⁺ conductivity of from 0.7 mS cm⁻¹ to 1.5 mS cm⁻¹.

18. A solid state electrolyte prepared by the method of claim 11, comprising lithium phosphate sulfide nanoparticles comprising Li₇P₃S₁₁, the lithium phosphate sulfide nanoparticles having an average particle size of from 100 nm to 500 nm.

19. The solid state electrolyte of claim 18, wherein:
(i) the nanoparticles of lithium phosphate sulfide are prepared from a solution comprising 10 mg ml⁻¹ of the precursors and the nanoparticles have an average particle size of from 100 nm to 120 nm; or
(ii) the nanoparticles of lithium phosphate sulfide are prepared from a solution comprising 20 mg ml⁻¹ of the precursors and the nanoparticles have an average particle size of from 150 nm to 450 nm.

20. The solid state electrolyte of claim 18, wherein:
(i) the nanoparticles of lithium phosphate sulfide are prepared from a solution comprising 10 mg ml⁻¹ of the precursors and the solid state electrolyte has a Li⁺ conductivity of at least 0.7 mS cm⁻¹; or
(ii) the nanoparticles of lithium phosphate sulfide are prepared from a solution comprising 20 mg ml⁻¹ of the precursors and the solid state electrolyte has a Li⁺ conductivity of at least 1.05 mS cm⁻¹.
